(19) United States
(12) Patent Application Publication
(10) Pub. No.: US 2005/0254130 A1
(43) Pub. Date: Nov. 17, 2005

(54) Device for guiding light

(76) Inventors: Wolfgang Graf, Eschbach (DE); Andreas Georg, Freiburg (DE); Peter NItz, Gundelfingen (DE); Christopher Buhler, Frieburg (DE); Andreas Gombert, Freiburg (DE); Volker Wittwer, Freiburg (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/505,212

(22) PCT Filed: Feb. 19, 2003
(86) PCT No.: PCT/EP03/01696

§ 371 Date: May 26, 2005

(30) Foreign Application Priority Data
Feb. 22, 2002 (DE) 102 07 564.6

(51) Int. Cl. G02B 5/08

(52) U.S. Cl. 359/604

(57) ABSTRACT

Described is a device for guiding light consisting of at least one partially translucent surface material, with a surface upper side, which has optically active surface structures for guiding and/or scattering light, as well as an optically switchable coating provided at least in partial areas of the surface structures, or at least two directly or indirectly opposing surface upper sides, of which one exhibits optically active surface structures for guiding and/or scattering light, and the other provides an optically switchable coating that covers at least parts of the surface upper side.

### TECHNICAL AREA

The invention relates to a device for guiding light consisting of at least one partially translucent surface material.

### PRIOR ART

Modern buildings increasingly exhibit large, glazed surfaces, as a result of which the incident sunlight reduces thermal energy demand during the heating period, and increased daylight exposure improves lighting in buildings. At the same time, however, undesired effects can be encountered, in particular overheating in the buildings on warm days, or glare caused by direct sunlight, e.g., at display workstations.

These problems are presently being countered through the use of static elements, e.g., tinted glazing with low solar transmission, porches with an awning or balcony in front of window surfaces, etc. Optically switchable elements, e.g., mechanically adjustable shading systems in the form of shades or Austrian blinds, or more recently, optically switchable windows, such as electrochromic or gasochromic windows, are able to counter overheating and unpleasant glare effects. Electrochromic systems are described, for example, in C. G. Granqvist, “Handbook of inorganic electrochromic materials”, Elsevier Amsterdam (1995), or “Electrochromism”, P. S. Monk, R. J. Mortimer, D. R. Rosseinsky, VCH Weinheim (1995). Electrochromic systems are related to so-called gasochromic systems, whose optical properties change through reaction with a gas, and which are also described, among other places, in DE 44 40 572 and EP 0 792 406 B1, or in “Mechanism of the gasochromic coloration of porous WO₃ films”, Solid State Ionics, Volume 127, Issues 34, Jan. 2, 2000, pp. 319-328, A. Georg, W. Graf, R. Neumann and V. Wittwer.

Also known from DE 38 22 796 A1 is a device and method for changing the light permeability of windowpanes, in particular dual-glazed windowpanes. In this case, an electrochromic material is incorporated between two glass panes, and changes its transmission properties during exposure to an electric voltage. In a particularly highlighted embodiment, numerous liquid crystal surface fields arranged in a matrix are provided between two glass panes, which are individually subjected to an electrical current, thereby making it possible to tint a windowpane with such a structural design in individual surface areas. However, light is not guided with this system.

Optically switchable systems have known materials that change their refractive index, optical activity, e.g., by rotating the polarization plane in liquid crystals, or alter their absorption index, to in this way induce adjustable absorption actions. The latter materials are referred to as electrochromic, gasochromic, phototropic/photochromic or photoelectrochromic materials, depending on the type of influence they exert. Also known are materials that undergo a transformation from a dielectric to metallic state, e.g., in metal hydride mirrors (e.g., see “Toward solid-state switchable mirrors using a zirconium oxide proton conductor”, Solid State Ionics, Volume 145, Issues-1-4, Dec. 1, 2001, pp. 17-24, Virginie M. M. Mercier and Paul van der Sluis, “Cycling durability of switchable mirrors”, Electrochimica Acta, Volume 46, Issues 13-14, Apr. 2, 2001, pp. 2173-2178, Anna-Maria Janner, Paul van der Sluis and Virginie Mercier).

By contrast, static elements bring about a lasting reduction in overall incident light, e.g., through window openings, in a desired fashion not just during warm times of the year, but also during wintertime, thereby diminishing the desired contribution of sunlight to heating a room during cold times of the year. On the other hand, mechanically adjustable systems enable a largely individual adjustment of shading level to the given light conditions, but such systems are often complex, expensive and also maintenance intensive.

One approach to avoiding glare effects inside of rooms involves the targeted guiding of direct sunlight into solid angle areas where no discernible glare can arise, e.g., toward the ceiling of an interior space. Optical elements that work based on optical refraction, reflection and/or internal total reflection are used for this purpose. Such optical elements are typically designed as light-transparent surface elements, whose surfaces, for example, have prismatic structures that transmit, divert, scatter or reflect the incident rays, depending on the angle of incidence. In the case of permanently installed surface elements of this kind, the seasonal variance in solar altitude causes direct sunlight to be specifically reflected over a specific period of time, e.g., during the summer months, while allowing it to pass through the light guiding system nearly unimpeded for the remaining time.

Another system for guiding light consists of complementary structures makes use of the fact that only a minimally small parallel ray shift takes place during passage through a thin, plane-parallel gap. As a result, an element that performs a shading function based on total reflection at specific angles of incidence can be provided with transparent properties by adding a complementary structure to the element. Such systems are known, for example, from DE 17 40 553, DE 11 71 370, U.S. Pat. No. 2,976,759, U.S. Pat. No. 3,393,034, U.S. Pat. No. 4,148,563, U.S. Pat. No. 4,519,675, U.S. Pat. No. 5,880,886, DE 195 42 832 A1 or DE 196 22 670.

In addition, the function of light-guiding prisms can be further expanded by making the prisms movable, so that the alignment of the respective prism surfaces relative to the light source can be specifically varied. Such systems are known from DE 1 497 348, DE 31 38 262 A1, U.S. Pat. No. 4,773,733, DE 195 42 832 A1 or DE 197 00 111 A1, in which structured lamellae or prism rods are pivoted around an essentially horizontal axis, as a result of which the light-guiding structures can be specifically aligned or made to follow the sun. However, the disadvantages associated with lamellar shades or Australian blinds apply to these movable systems, namely high procurement costs and susceptibility to disruption owing to mechanical failure.

Therefore, prior art does describe measures to avoid overheating in buildings, e.g., optically switchable windows, along with methods to avoid glare caused by guiding light, e.g., using prismatically structured geometries.

However, the requirements that would have to be placed on reducing the transmission of an optically switchable window to avoid glare are very stringent, so that corresponding windows are not available or very expensive to manufacture, and also exhibit additional disadvantages during operation, such as longer switching times, lower transmission in the decolored state, or lower long-term stability. At the same time, however, suppressing glare in this way would also diminish the desired effect of reducing heating energy, in particular in winter.

By contrast, known light guiding devices able to prevent glare only negligibly help to avoid overheating on warm days, if at all, especially since they are in most cases limited to deflecting direct sunlight, and hence cannot effectively mask diffuse sky light.

Static coatings in conjunction with such light guiding devices can markedly reduce overheating in warm periods of the year through back reflection, light scattering or absorption. However, these masking mechanisms only make it possible to utilize a slight portion of solar energy for heating a room during the cold time of year.

One special disadvantage to optical devices for geometric light guiding relates to the unavoidable, manufacturing-related deviations of actual light guiding structures from the ideal structure. In particular corners are rounded in reality. These rounded areas result in undesired glare effects, in particular when looking directly at the window.

### EXPLANATION OF THE INVENTION

The object of the invention is to further develop a device for guiding light out of at least one partially translucent surface material, preferably designed as a window element or integratable into one, in such a way that the device avoids the disadvantages specified above in prior art. In particular, the object is to indicate a light guiding device that combines all advantages described above for the respective individual light deflection systems. In particular, the light guiding device according to the invention is intended to avoid all instances of glare caused by the direct incidence of sunlight inside a room, or by manufacturing-related rounded areas on corners of surface structures, and beyond that to ensure effective protection against overheating, in particular during warm times of the year. At the same time, the goal is to meet the requirement of allowing enough light inside a room while effectively suppressing any danger of glare, primarily in cold times of the year. In addition, the object is to indicate a light guiding element with optical properties having a high optical selectivity and functionality, i.e., to enable light deflection with an exceedingly high angular selectivity relative to the angle of incidence of the sunlight on the device. Finally, the object is to keep manufacturing-related costs as low as possible, thereby yielding an economically interesting product that is also suitable above all for applications involving large surface areas.

The object of the invention is resolved as specified in claims 1 and 4. The subclaims relate to features that advantageously further develop the inventive idea. Also indicated is a method according to the invention for manufacturing the light-deflecting devices.

The first solution according to the invention provides for a light-guiding device consisting of at least one partially translucent surface material, with at least one surface upper side, which has optically active surface structures for guiding and/or scattering light.

In this conjunction, the words “at least partially translucent” are intended to denote a type of material that can be exposed to solar radiation from the visible spectral region with little or no transmission losses.

In a broader sense, this also applies to those spectral regions immediately bordering the visible spectral region at shorter and especially longer wavelengths.

Also provided at least in partial areas of the surface structures is an optically switchable coating, which covers the surface structures entirely, or only in limited partial areas, preferably along edge progressions, depending on user requirements.

As an alternative to directly coating the surface structures with the optically switchable layer, a second surface upper side situated opposite, preferably parallel to, the surface upper side provided with the surface structures can be provided with an optically switchable layer, at least in partial areas. The second surface upper side can either be separated from the first surface upper side, e.g., by two separate surface materials, or connected as a single piece with the first surface upper side, e.g., in the form of a front and back side of a surface material designed as a windowpane.

In a simplest embodiment of the device according to the invention, the structured surface upper side of a known optical light guiding surface element is provided with an optically switchable layer. This combination advantageously merges the advantages of classic light-guiding or scattering optical surface elements with those optically switchable systems described in the introduction to the specification, thereby suppressing glare effects on the one hand, and avoiding overheating effects during warm times of the year on the other. This makes it possible to effectively suppress the danger of glare even during cold times of the year, while the solar radiation flux penetrating into a room markedly helps to warm up interior spaces given a corresponding increase in transmission of the optically switchable layer. The disadvantages described for individual systems are not encountered in the device according to the invention. The manufacturing-related glare strips along rounded corner passages of the light-guiding surface structures are locally diminished in terms of their glare effect by the light-absorbing layer by providing the optically switchable layer with an elevated glare effect on the surface structures, preferably on precisely those surface areas.

The term “optically active surface structures” primarily encompasses structural geometries that provide optically active interfaces, at which light is refracted, reflected or scattered according to the laws of geometric optics as it passes through. This applies to macroscopic structural elements whose structural dimensions indeed have interfaces in the centimeter and decimeter range. Cracks, gaps or slits in the surface upper side of a surface material, e.g., a glass pane, typically already represent such surface structures at whose interfaces rays of light are deflected as a function of the respective interface inclinations relative to the incident light. In like manner, however, three dimensional structures raised from the surface upper side, such as prisms, squares, pyramids, lens bodies, etc. also represent suitable surface structures that can be combined according to the invention with switchable coatings. Finally, it is also conceivable to form cavities by directly linking two flat materials with a corresponding surface structure, which also incorporate interfaces and deflect light. However, the above term “optically active surface structures” is also intended to include optically active microstructures whose optical deflection capacity cannot be exclusively described by the laws of geometric optics. Also conceivable are combinations of the macro and microstructures mentioned at the outset.

As will be explained in detail below, the targeted light guiding device consisting of at least one partially translucent surface material can be used in a particularly advantageous manner as a window element or part of a window element, preferably for buildings, but also in specific instances for other locations, e.g., vehicles like ships, cars and planes. Also conceivable is use in display elements, e.g., projection screens or backlit displays.

In connection with the preferred use of the device according to the invention for guiding sunlight into a room, preferably in buildings, one objective is to miniaturize the structures necessary for guiding light, not least for const considerations. So-called optical near-field effects that cannot be described by laws of geometric optics become important when miniaturizing such surface structures. When sunlight hits such microstructures, which typically have structural dimensions of 100 μm or less, preferably less than 20 μm, diffraction-induced near-field effects explainable by interference effects arise, the effective manifestation of which depends very heavily on the angle of incidence of the sunlight hitting the microstructures.

Such microstructures, whose effect and configuration are described, among other places, in DE 100 28 426 A1, are just as advantageously suitable for use as structural surfaces for guiding and/or scattering light, which can be utilized either in combination with the macroscopic, optically active surface structures, wherein the macroscopic, optically active surface structures are in this case provided with the near-field effect-inducing microstructures either over their entire surface or only in specific surface areas, or are applied in place of the macroscopic, optically active surface structures onto a surface upper side, at least in partial areas. Precisely these microstructure surfaces are covered according to the invention at least in partial areas of their surface with an optically switchable layer, whose optical effect on the sunlight passing through the microstructure surface is significantly influenced by the near-field effects induced by the microstructures. It is particularly advantageous to provide only those areas of the microstructure with the optically switchable layer on which especially high near-field intensities arise for specific angles of incidence at which sunlight hits the microstructure surface.

The microstructure surface completely coated with a light-induced, optically switchable layer, preferably consisting of photochromic material, could be locally tinted at locations of higher near-field intensity, which can indeed result in optically interesting phenomena.

In addition, further studies of the device according to the invention have surprisingly shown that, aside from optically switchable coating materials, optically active layers whose absorption, transmission and/or reflection behavior is independent of time, i.e., chronologically invariable, as is the case for dielectric or metallic layer materials, for example, exhibit comparably good optical light guiding or scattering properties, as can be observed when using the device according to the invention described above, provided the optically active layers are used at least in combination with a microstructure surface.

In a second alternative approach, a light guiding device consisting of at least one partially translucent material with a surface upper side is therefore designed in such a way that the surface upper side provides optically active surface structures for guiding and/or scattering light, wherein at least partial areas of the optically active surface structures provide microstructures covered at least partially with an optically active layer, which utilizes near-field effects induced by the microstructures for its optical effect.

It was surprisingly shown that the danger of glare could be kept low on the one hand, while on the other hand influencing the solar radiation flux in such a way as to avoid overheating in warm times of the year and ensure a marked supply of warmth in cold times of the year.

Similarly surprisingly good results could also be achieved by having the surface upper side of the surface material be provided exclusively with a microstructure surface, i.e., without the additional provision of macroscopic surface structures. In this case, the microstructures are at least partially covered with an optically active layer, which utilizes near-field effects induced by the microstructures for its optical effect.

The coating is only of special importance for the advantageous optical effect of the microstructured surface upper side in those surface areas of the microstructures where intensity maximums and minimums in the near field arise during exposure to light. Only upper edge progressions of the microstructures are preferably covered by the optically active layer, e.g., one designed as a thin metal layer and having constant reflection and absorption properties. The use of dielectric layers having specific, constant transmission properties is basically conceivable as well.

As already briefly touched upon above, microstructures are indeed also taken to mean differently shaped, geometric microstructure elements measuring 100 μm in size, preferably less than 20 μm, and a preferred aspect ratio of greater than 0.2.

Typical three dimensional microstructure elements respectively raised over the surface upper side include prismatic, square, parabolic, convexly or concavely curved or pyramidal structural elements, whose structural dimensions trigger interference effects when correspondingly exposed to sunlight that result in field modulations in the near field on the order of the wavelength of the light incident on the microstructures. It was shown that a pivotal influence can be exerted on near field formation via the locally limited coating of microstructure flanks or edges, preferably with a metal layer. Such microstructures exhibit a very high angular dependence relative to the light incident on the microstructures in terms of its optical deflection behavior. The masking behavior depending on the angle of incidence can be set in a highly precise manner with respect to the optical deflection capacity of the microstructures via the suitable, selective coating of microstructure flanks or edges.

The developing near field effects can also influence the transmission properties of the entire translucent surface element wave length-selectively as a function of the angle of incident of the light hitting the microstructures. As a result, suitably coating the microstructure makes it possible to introduce a targeted downward adjustment of transmission behavior for sunlight from the longer-wave spectrum at high angles of incidence of the kind encountered during summertime in our latitude to prevent overheating inside of rooms, while simultaneously ensuring that long-wave radiation can pass through the surface material virtually intact at the flat angles of incidence encountered in our latitude during cold times of the year.

The inventive combination of a device having microstructures optically active at least in partial areas with a selective coating made of optically active material that is not necessarily optically switchable represents a device for use preferably as a shading element, which merges the advantages recognized at the outset in prior art while avoiding it disadvantages.

In addition to the proposed use for the selective, local coating of microstructures with an optically active layer, which exerts a dielectric or absorbing effect, and has reflection, transmission and/or absorption properties independent of time, it is of course also possible to use optically switchable layer materials of the kind proposed in conjunction with the first alternative solution described above.

All known optically switchable materials are essentially suitable for the light guiding device according to the invention. Without calling into question the fundamental suitability of remaining materials, the layer materials especially preferred from the group of optically switchable layer materials with electrochromic, photochromic, phototropic, photoelectrochromic, thermochromic, thermotropic or gasochromic switching properties based on present knowledge for realizing the device according to the invention are gasochromic. Particularly suitable for this purpose are transitional metal oxides, e.g., tungsten oxide, tungstates, nioboxide, molybdenum oxide, molybdates, nickel oxide, titanium oxide, vanadium oxide, iridium oxide, manganese oxide, cobalt oxide or mixtures of the aforementioned oxide types. Also suitable as gasochromic materials are metal hydrides, e.g., La_{1-z}Mg_{z}Hₓ, Y_{1-z}Mg_{z}Hₓ, Gd_{1-z}Mg_{z}Hₓ, Yh_{b}, LaH_{b}, SmH_{b}, NiMg₂Hₓ, CoMg₂Hₓ or mixtures thereof, with z values in the 0 to 1 range, x values in the 0 to 5 range, and b values from 0 to 3, or switchable polymers, such as polyviologens, polythiophenes or polyanilines, or Prussian Blue.

Layer thicknesses of between 100 nm to 100 nm are selected in the case of the transitional metal oxides described above for planar or limited planar deposition onto the corresponding surfaces. Particularly suitable layer thicknesses measure 200 to 600 nm. However, if the gasochromic layer material is selected from the group of metal hydrides, layer thicknesses of between 10 nm and 500 nm, preferably between 20 nm up to 50 nm, are already sufficient. The latter material class is preferably suitable for selectively coating the smallest surface sections on the microstructures, in which only the corner passages or specifically aligned lateral flank surfaces relative to the incident light are covered by just a think layer.

In order to improve the switchability of the gasochromic layer materials described above, the layer materials are combined with catalytic materials. Such catalytic materials include platinum, iridium, palladium, rhodium osmium, rhenium, nickel, ruthenium or mixtures of the aforementioned metal types. The catalysts designed as layers preferably exhibit preferred layer thicknesses of 10 nm or less, preferably of 3 nm.

The use of gasochromic layers in combination with light guiding or scattering surface structures has the following advantages, in particular for selectively coating specific areas of the surface structure:
The layer structure is particularly simple. Especially during a selective coating of specific areas of the surface structure, this greatly simplifies coating outlay relative to complex multi-layer systems.
Gasochromic layer systems generally combine a comparatively thick gasochromic layer, e.g., a transitional metal oxide typically 100 nm to 1000 nm thick, preferably 200 nm to 600 nm, with a thin catalyst layer, typically thinner than 10 nm, preferably thinner than 3 nm.
Selective application to specific areas of the surface structure can readily be performed using deposition methods, e.g., vapor depositing or sputtering, in which the layer particles expand in a straight line, thereby producing a shading effect. Limiting the angular range of these layer particles during the deposition process makes it possible to readily achieve a selective coating of the surface structure, as will be described further later on. However, this is generally also associated with a reduction in the effective deposition rate. Gasochromic layer systems provide a good opportunity to apply the thick, gasochromic layer in a planar manner, and apply the thin catalyst layer selectively, thereby generating a coating that switches only in the areas with the catalyst. The disadvantage to the reduced deposition rate for the catalyst layer is then not serious, since very thin layers are sufficient here anyway.
A gasochromic coating selectively deposited in specific areas can be switched just as easily as a planar coating via flooding with reactive gases. In layer systems requiring electrical contacting, e.g., electrochromic, the switching outlay can rise unequally given selective coating.
To protect the optically active surface structures, it is often also necessary to embed them in an intermediate space in the pane between two substrates. This intermediate space in the pane is then also available to be flooded with reactive gases of the kind required for gasochromic layers.
Similarly, cavities of the kind generated by putting together two complementary structures can be equipped inside with gasochromic layers, and then flooded with reactive gases.

In like manner, the aforementioned gasochromic material classes are suitable as electrochromic layer materials, and must in this case only be hooked up to an electrical control potential for switching their optical transmission behavior, and not be exposed to a targeted gas flow, as in the gasochromic operating mode.

Liquid crystals are not particularly suitable if selectively determined areas of the surface structure are to be made switchable, since it is very difficult to encapsulate them over selective areas. In particular if the one electrode surface of a liquid crystal system is applied to larger structural depths, it may become necessary to incline the second one parallel to the first one, which becomes very complicated. The use of liquid crystals on large surfaces is basically complicated and expensive.

Much the same holds true for the application of “suspended particle devices” (SPD). Phototropic and thermotropic materials require comparatively large layer thicknesses (typically greater than 10 μm or 100 μm), many organic photochromic materials of the kind used in sunglasses typically greater than 1 μm. As a result, they are not particularly well suited, in particular for selectively coating specific structural areas.

By contrast, those optically switchable systems having thin layers with thicknesses under 10 μm, preferably less than 1 μm, are well suited. Examples of these include gasochromic, electrochromic, photoelectrochromic, photochromic or thermochromic layer systems. Such photoelectrochromic layer systems are described, for example, in “New photoelectrochromic device”, Electrochimica Acta, Volume 46, Issues 13-14, Apr. 2, 2001, pp. 2131-2136, A.

Hauch, A. Georg, S. Baumgaertner, U. Opara Krasovec and B. Orel, or in “User controllable photochromic (UCPC) devices”, Electrochimica Acta, Volume 44, Issue 18, May 1, 1999, pp. 3017-3026, Gimtong Teowee, Todd Gudgel, Kevin McCarthy, Anoop Agrawal, Pierre Allemand and John Cronin. Suitable photochromic and photoelectrochromic systems are described in DE 198 16 675 A1, for example. Thin thermochromic layer systems include VO2, e.g., doped with tungsten or molybdenum (see “Thermochromic glazing of windows with better luminous solar transmittance”, Solar Energy Materials and Solar Cells, Volume 71, Issue 4, Mar. 1, 2002, pp. 537-540, Moon-Hee Lee).

Of the switchable systems described above, several cannot be switched in a controlled manner, i.e., they react passively to external influences, in particular temperature (thermochromic, thermotropic) and luminous intensity (photochromic, phototropic). In comparison to these, the actively controllable systems (e.g., gasochromic, electrochromic, photoelectrochromic) offer the advantage that they can be influenced to a greater degree.

A series of alternative coating techniques are suitable for manufacturing the device according to the invention, whose optically active surface structures, whether they assume macroscopic or microscopic dimensions, are provided with either locally selective layer deposits, whether they be optically switchable or static.

Known vapor depositing or sputtering processes in which the individual coating particles expand along a straight line on the surface to be coated are suitable. Therefore, inclined coating makes it possible to selectively coat those lateral flanks of the surface structures facing the respective coating source, while the lateral surfaces facing away from the coating source or shaded from other structures remain uncoated.

Sputtering processes are typically executed under an argon atmosphere and with pressure conditions under which the average free path length of the gas particles is less than or roughly the same as the distance from the sputtering source (target) to the substrate, so that the sputtering particles can be expected to scatter. By contrast, if high-mass sputter particles like tungsten or platinum are selected, and a light sputtering gas like helium or neon is additionally used, the heavy sputtering particles can expand nearly along a straight line, and form flank-selective coatings on geometric structures. In addition, it is advantageous to use suitably applied masks during the sputtering process if the objective is to only expose specific angular regions for coating purposes relative to the straight line along which the sputtering particles expand. However, much the same thing can be accomplished by inclining the target or substrate, e.g., using rollers for guiding in the case of a film coating.

Wet chemical coating methods are also conceivable, such as immersion, spraying, centrifuging, doctoring or pressing, but the surface structures to be coated must be preprocessed in a first step in such a way that only selective flank areas are coated via wet chemical deposition as the entire surface structure is brought into contact with the coating material. This is achieved by having certain structural surface areas exhibit hydrophilic, hydrophobic, lipophilic or lipophobic surface properties. These surface properties can also be generated by small structures, i.e., structures smaller than 10 μm. If the structures are held to less than the length of a light wave, i.e., less than 400 nm, their influence on the optical properties is not that great in the area of the solar radiation. For example, they can be transferred to a film substrate surface via mechanical embossing. Depending on the composition of the coating solutions, selective flank coatings can be generated in this way.

Also conceivable are combinations of various coating methods, for example the combined application of vapor deposition or sputtering, as well as wet chemical methods. A sputtering process can be used to selectively deposit separating layers on limited substrate surfaces. In an ensuing wet chemical method, for example, an optically switchable layer is applied over the entirety of the surface substrate. As the separating layer is then detached, the optically active layer can subsequently be locally removed, leaving the optically active layer only on the remaining surface areas.

The opposite also holds true, as the entire surface upper side furnished with optically active surface structures can be coated with an optically active layer, for example, and then covered selectively with a blocking layer. This blocking layer can prevent the switching function in the case of an optically switchable layer as the optically active layer, and greatly impair its optical properties in the case of a static layer.

In optically switchable multi-layer systems, e.g., a thicker gasochromic layer combined with a thinner catalyst layer, it is also possible to separate only one layer selectively, e.g., the thinner layer, and have the remaining layers over the entire surface, so that the switching function is only present at locations where all individual layers are present.

Other suitable methods include those in which the coating is influenced by an illumination of the structured surface, and layer deposition takes place, for example, precisely at locations with a higher or lower luminous intensity. Possible examples of this are the process of polymerizing out monomers under UV illumination or illuminating photoresist structures with subsequent development and, if necessary, additional coating and/or liftoff processes.

### BRIEF DESCRIPTION OF THE INVENTION

The invention will be described by example below based on exemplary embodiments making reference to the drawing, without limiting the overall inventive idea. Shown on:

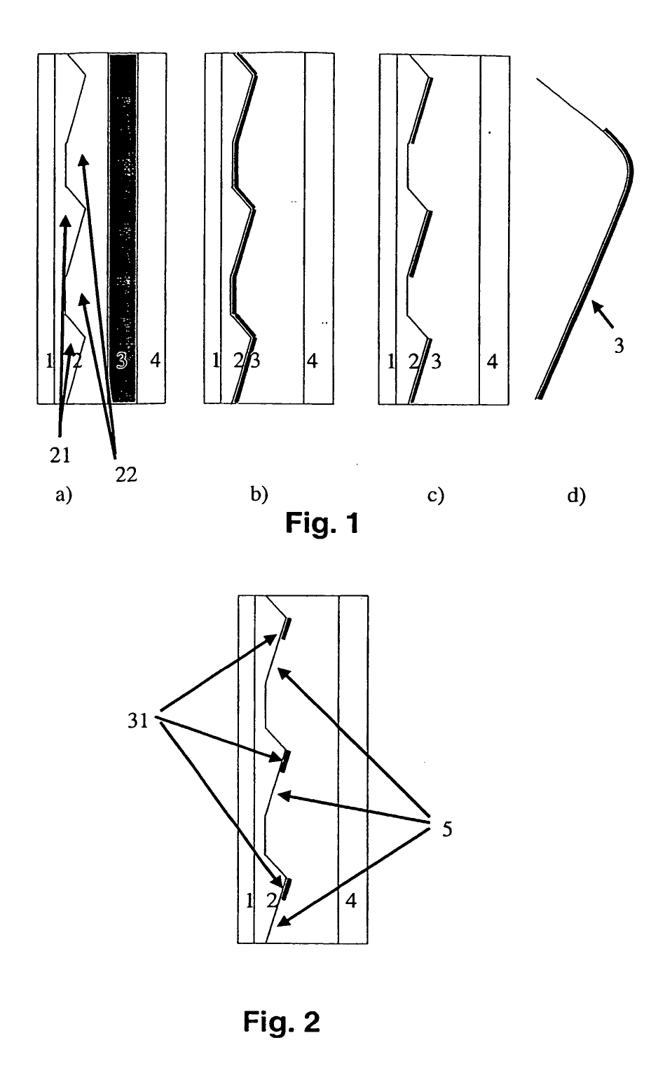

FIG. 1a to d are cross sectional views of a window element in which the device configured according to the invention is used for guiding light;

FIG. 2 is a window element with optically active surface structures and microstructures;

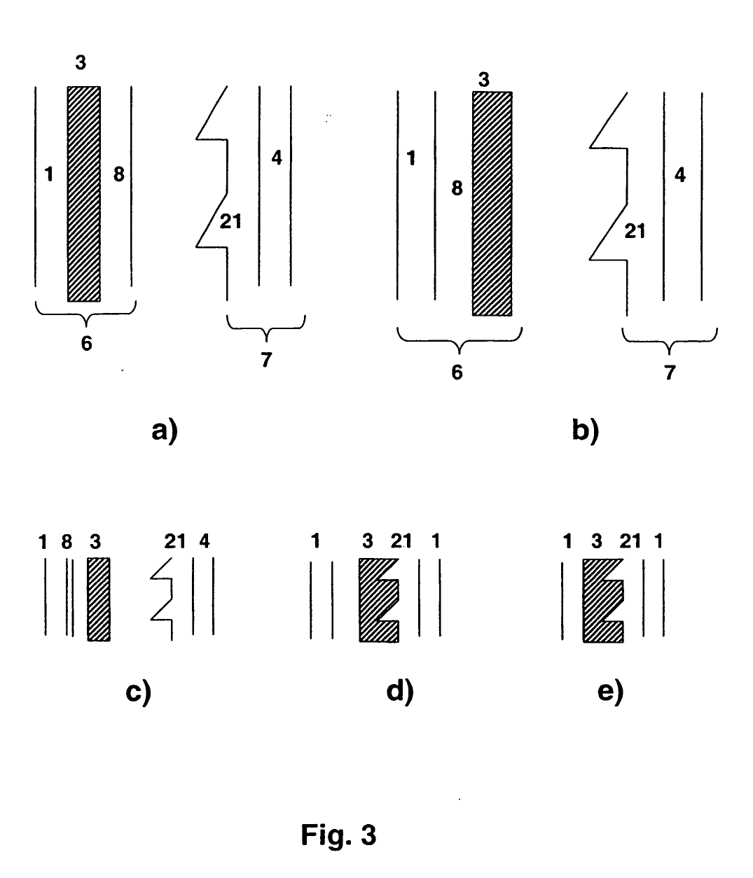

FIG. 3 a-e is a window element thermotropic layer material, and on

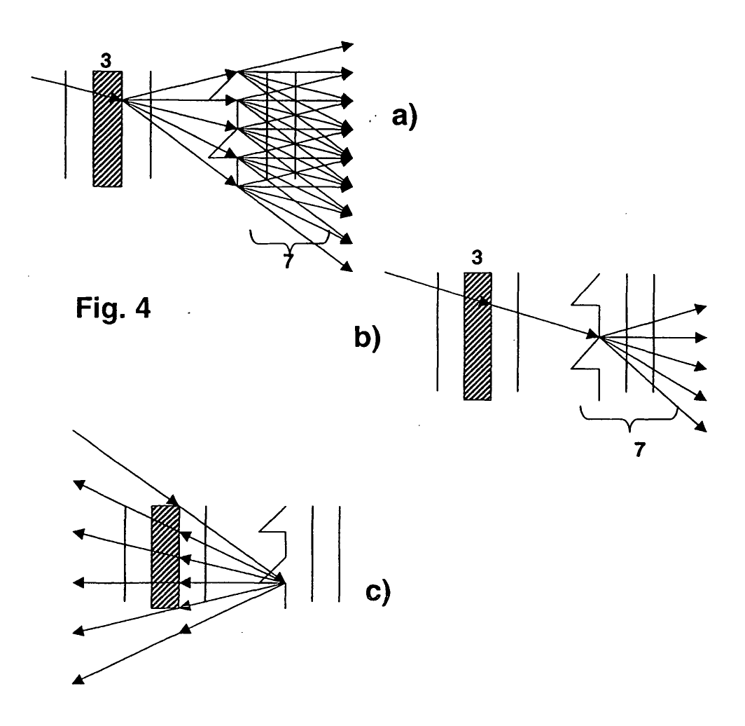

FIG. 4 a, b, c are views showing the ray progression through a window element with thermotropic layer material.

### WAYS FOR IMPLEMENTING THE INVENTION, COMMERCIAL APPLICABILITY

The light guiding device described above comprised of at least one partially translucent surface material is advantageously suited for integration into a window element, which will be described in detail drawing reference to the following exemplary embodiments.

FIG. 1a shows a diagrammatic cross section through a double-glazed window element, which is bordered on both sides by opposing window glass panes 1 and 4. Provided within the gap between the windowpanes 1 and 4 is the surface material 2 designed as a kind of glass pane, the left surface upper side of which in the figure provides macroscopic surface structures 21. The surface structures 21 each have three lateral flanks, of which one is oriented parallel to the back side of the surface material 2.

The three lateral flanks in the exemplary embodiment shown on FIG. 1 along with the glass pane 2 enclose a cavity 22, which is enveloped by three optically active interfaces, which essentially determine the optical deflection capacity for the sunlight incident on the window element into the interior of a room.

The exemplary embodiment according to FIG. 1a assumes that glass pane 1 is the outer pane, and glass pane 4 is the inner pane of a window element. Provided between the structured pane 2 and the inner pane 4 is an optically switchable layer system 3, e.g., consisting of an optically switchable layer and a catalyst, e.g., WO₃ and platinum. The pane cavity 22 can be filled alternately with a reducing gas, e.g., diluted H₂, and an oxidizing gas, e.g., diluted 02, as a result of which the layer becomes colored or discolored, e.g., in the case of WO₃ and platinum. Additional details relating to such an optically switchable system may also be gleaned from DE 44 40 572.

The optically switchable layer system 3 acts to reduce the glare effect of the geometric structure 21, which results from the production process owing to the lack of edge configurations (keyword edge rounding).

FIG. 1b shows an exemplary embodiment in which an optically switchable layer 3 is provided over the entirety of the surface structure of the surface material 2. By contrast, FIG. 1c shows an embodiment in which only specific flanks of the surface structure 21 are provided with an optically switchable coating 3. The structural dimensions can be macroscopic, e.g., greater than 100 μm, or microscopic, e.g., less than 100μ.

Such a structure can be manufactured, for example, by embossing a light-guiding structure in a plastic film. The latter is then selectively coated with a gasochromic layer via vapor deposition or sputtering, after which the film is applied to the inside of a double glazed pane. Typical structural can be periodic prisms with a translucent area, as sketched on FIG. 1, wherein individual flanks and/or edge roundings are selectively coated. Typical structural dimensions here range between 10 and 50 μm, for example.

FIG. 1d provides a detailed view of a manufacturing-induced edge rounding, which can lead to undesired glare effects. However, specifically coating the edge area with the optically switchable layer 3 makes it possible to effectively reduce the glare effects caused by rounding.

Particularly advantageous combinations also result from light-guiding surface structures and photochromic layer materials. Photochromic layer materials typically discolor on exposure to light, so that in particular those layer areas become tinted that are exposed to a high luminous intensity. For example, light-guiding structures with a corresponding geometric design make it possible to guide direct sunlight to specific locations of the photochromic layer, thereby inducing local discolorations, while the photochromic layer at other remains translucent at other locations, for example. The opposite reaction is also conceivable in principle, i.e., a photochromic material that discolors during exposure to light, but otherwise remains tinted or reflective.

FIG. 2 shows an exemplary embodiment of a window element comparable to the drawing on FIG. 1c, but the surface element 2 incorporated between the windowpanes 1 and 4 has microstructures 5, on which an optically active layer 31 is applied not necessarily designed as an optically switchable layer is applied, also only in partial areas. The microstructures 5 on FIG. 2 are greatly magnified to improve visibility.

Locally limited areas of the microstructures 5, preferably the microstructure edge progressions, are provided with metal coatings 31, which are able to influence the near field effects induced by the microstructures 5 during irradiation in a specific way, and hence determine the light deflection capacity of the entire window element.

The provision of microstructures 5 according to the exemplary embodiment on FIG. 2 essentially makes it possible to realize a sharp angular selectivity, i.e., the light is reflected back during exposure to direct sunlight and with the sun in a high position over the horizon, as occurs primarily in the summer, while the light is allowed through at low sun positions, mainly in the winter. Wavelength selectivity can essentially also be achieved. This affords protection against overheating in the summer while simultaneously making use of the sunlight to heat up the building in winter. At the same time, deflecting the direct sunlight, e.g., to the ceiling of the interior space during winter with the sun in low positions makes it possible to avoid glare.

The microstructures also provide for a near field that by nature depends much more on wavelength than the optical function of macroscopic structures, in which geometric optics determine the effect, which ideally is independent of wavelength.

With respect to protection against overheating, it is advantageous to mask out, or best reflect, the non-visible region, in particular the near infrared region, of the sunlight, but allow the visible region through to illuminate the interior space. The inventive combination of microstructures and optically active layers permits sharper wavelength selectivity, a lower absorption and the use of simpler layers, e.g., single layers, such as metals, while placing less demand on the substrate.

FIG. 3a to 3e show additional variants for a light-guiding system, which can be integrated into window elements, preferably window elements with dual glazing, similarly to the exemplary embodiments drawing reference to FIG. 1a-d.

FIG. 3a shows a diagrammatic cross section through a multi-layer window structure, which provides a thermotropic composite panel 6 arranged as the outer pane a distance away from an inner pane 4 designed as a prismatic glazing. In this case, the thermotropic composite panel 6 consists of three layers, wherein a thermotropic material is held between two glass panes otherwise transparent to sunlight. Particularly suited for use as the glass pane facing the prismatic glazing 7 is a so-called Low-e layer 8, which consists of a material that radiates little thermal radiation. The prismatic glazing 7 preferably consists of an inner pane 4 transparent to normal sunlight, with a surface structured film 21 applied thereto. A gas space is enclosed between the Low-e layer 8 and the film 21.

As an alternative to the embodiment shown on FIG. 3a, the exemplary embodiment according to FIG. 3b also makes it possible to not encapsulate the thermotropic material on both sides by glass panes or the like, but rather to provide the prismatic glazing 7 immediately opposite on a composite layer comprised of an outer pane 1 transparent to sunlight and a Low-e layer 8 applied thereto.

FIG. 3c to d provide further configuration variants. On FIG. 3c, the optically switchable layer 3 preferably consisting of thermotropic material is self-contained between the composite layer comprised of the outer pane 1 and Low-e layer 8, as well as the inner pane 4 provided with the structured surface 21. On FIG. 3d, the outer pane 1 is spaced apart from the optically switchable layer 3, which is applied directly to the structured surface 21. On FIG. 3e, the outer pane 1 directly contacts the optically switchable layer 3, which is applied to the structured surface 21 as on FIG. 3d.

The thermotropic composite windowpanes described above make it possible to use suitable thermotropic materials to indicate a completely autonomously operating light guiding system, which allows warming radiant flux to pass into the room in winter, while avoiding overeating effects in summertime. This is because, as opposed to the transmission behavior of conventional thermotropic materials, which are transparent when cold and diffusely scattering when warm, use is made of specific thermotropic materials with the opposite transmission behavior, i.e., diffusely scattering when cold, and largely transparent to sunlight when warm, as is the case, for example for paraffins or other latent storage materials, such as salt solutions, yielding the radiation situations shown on FIGS. 4a and b.

Assuming on FIG. 4a that cold temperatures predominate, i.e., in particular in wintertime, at which the thermotropic layer material assumes a turbid or diffuse state, diffusely scattering incident sunlight in the direction of the prismatic glazing 7. In particular, the prismatic glazing 7 is designed in such a way as to be largely reflective for high solar altitudes in the summer, while transmitting at lower solar altitudes, in particular during wintertime. Since the introduction of solar rays into a room is desired at wintertime temperatures, as described in the above case, the diffuse scattering of light on the thermotropic material layer 3 nearly precludes the reflection effect of the prismatic glazing 7, so that the solar radiation flux can get inside the room largely unimpeded (FIG. 4a). This stands in contrast with the situation at higher temperatures that predominate during summertime according to the depiction on FIG. 4b. In this case, heating causes the thermotropic layer material 3 to assume transparent properties, as a result of which the sunlight streaming in from outside hits the light-guiding surface structures of the prismatic glazing 7 virtually unscattered. At a suitably high solar altitude, only rays of the sun that hit the prismatic glazing at a specific angle are guided inside the room. The far higher share of rays is reflected back by the prismatic glazing 7 as a result of its prismatic function (as shown on FIG. 4c).

### REFERENCE LIST

1 Outer pane
2 Structured surface material
21 Surface material
22 Cavity
3 Optically switchable layer
31 Optically active layer
4 Inner pane
5 Microstructure
6 Thermotropic composite panel
7 Prismatic glazing
8 Low-e layer

1. A device for guiding light consisting of at least one partially translucent surface material, with
a surface upper side, which has optically active surface structures for guiding and/or scattering light, as well as an optically switchable coating provided at least in partial areas of the surface structures, or
at least two directly or indirectly opposing surface upper sides, of which one exhibits optically active surface structures for guiding and/or scattering light, and the other provides an optically switchable coating that covers at least parts of the surface upper side.

2. The device according to claim 1, characterized in that the optically active surface structures at least in partial areas provide microstructure surfaces that are covered at least in part by an optically switchable layer, which uses near-field effects triggered by the microstructures and based on diffraction and interference effects for their optical effect.

3. The device according to claim 1, characterized in that the optically active surface structures are designed as microstructures.

4. The device for guiding light consisting of at least one partially translucent surface material, with
a surface upper side, which has optically active surface structures for guiding and/or scattering light, which at least in partial areas provide microstructure surfaces that are covered at least in part by an optically active layer, and use near-field effects triggered by the microstructures and based on diffraction and interference effects for their optical effect, or
a surface upper side, which has a microstructure surface for guiding and/or scattering light, which is covered at least in part by an optically active layer, and uses near-field effects triggered by the microstructures for their optical effect.

5. The device according to claim 2, characterized in that the microstructures exhibit average structural periods of less than 100 μm in size, preferably less than 20 μm, and an aspect ratio, i.e., ratio of structural height to structural period, of greater than 0.2.

6. The device according to claim 4, characterized in that the optically active layer is applied exclusively to areas on the microstructure surface where excessively higher or lower near field intensities arise on the microstructure surface, i.e., intensity maximums and minimums generated on the microstructure surface owing to diffraction and interference effects, at specific angles of incidence for light relative to the surface upper side

7. The device according to claim 4, characterized in that the optically active layer has absorption, transmission and/or reflection behavior is independent of time.

8. The device according to claim 4, characterized in that the optically active layer is an optically switchable layer.

9. The device according to claim 1, characterized in that the optically switchable layer is selectively applied to specific areas of the surface structure.

10. The device according to claim 1, characterized in that the optically switchable layer is thinner than 10 μm, preferably thinner than 1 μm.

11. The device according to claim 1, characterized in that the optically switchable layer exhibits gasochromic, electrochromic, photochromic, photoelectrochromic or thermochromic layer material.

12. The device according to claim 1, characterized in that the switching function of the optically switchable layer can be actuated.

13. The device according to claim 12, characterized in that the optically switchable layer exhibits a gasochromic, electrochromic or photoelectrochromic layer material.

14. The device according to claim 11, characterized in that the gasochromic layer material is selected from the following material classes:
transitional metal oxides, e.g., tungsten oxide, tungstates, nioboxide, molybdenum oxide, molybdates, nickel oxide, titanium oxide, vanadium oxide, iridium oxide, manganese oxide, cobalt oxide or mixtures thereof,
metal hydrides, e.g., La_{1-z}Mg_{z}Hₓ, Y_{1-z}Mg_{z}Hₓ, Gd_{1-z}Mg_{z}Hₓ, Yh_{b}, LaH_{b}, SmH_{b}, NiMg₂Hₓ, CoMg₂Hₓ or mixtures thereof, with z values in the 0 to 1 range, x values in the 0 to 5 range, and b values from 0 to 3, or
switchable polymers, such as polyviologens, polythiophenes or polyanilines, or Prussian Blue.

15. The device according to claim 14, characterized in that the layer material consists of
transitional metal oxides having a layer thickness ranging from 100 nm to 1000 nm, preferably 200 nm to 600 nm, or
metal hydrides with a layer thickness ranging from 10 nm to 500 nm, preferably 20 nm to 50 nm.

16. The device according to claim 11, characterized in that the gasochromic layer material is actively connected with catalytic material.

17. The device according to claim 16, characterized in that the catalytic material is designed as a type of layer, and contains platinum, palladium, rhodium, osmium, rhenium, nickel, ruthenium or mixtures thereof.

18. The device according to claim 17, characterized in that the catalytic layer has a layer thickness of less than 10 nm, preferably less than 3 nm.

19. The device according to claim 1, characterized in that the optically switchable layer exhibits phototropic or thermotropic layer material.

20. The device according to claim 19, characterized in that the optically switchable layer is applied at least to partial areas of a surface upper side, and spaced indirectly or directly apart from the surface upper side provided with optically active surface structures for guiding and/or scattering light.

21. The device according to claim 20, characterized in that the optically switchable layer is incorporated between two surface elements transparent to sunlight.

22. The device according to claim 19, characterized in that the thermotropic layer material is diffusely scattering when cold, and largely transparent when warm.

23. The device according to claim 22, characterized in that the thermotropic layer material contains paraffins or latent storage material, such as salt solutions.

24. The device according to claims 11, characterized in that the electrochromic layer material can be selected from the material classes:
transitional metal oxides, e.g., tungsten oxide, tungstates, nioboxide, molybdenum oxide, molybdates, nickel oxide, titanium oxide, vanadium oxide, iridium oxide, manganese oxide, cobalt oxide or mixtures thereof,
metal hydrides, e.g., La_{1-z}Mg_{z}Hₓ, Y_{1-z}Mg_{z}Hₓ, Gd_{1-z}Mg_{z}Hₓ, Yh_{b}, LaH_{b}, SmH_{b}, NiMg₂Hₓ, CoMg₂Hₓ or mixtures thereof, with z values in the 0 to 1 range, x values in the 0 to 5 range, and b values from 0 to 3, or
switchable polymers, such as polyviologens, polythiophenes or polyanilines, or Prussian Blue.

25. The device according to claim 1, characterized in that the optically active surface structures are given macroscopic geometries rising vertically to the surface upper side of the surface material or take the form of cuts or recesses in the surface material, and exhibit interfaces at which light is refracted or diffracted according to the laws of geometric optics.

26. The device according to claim 1, characterized in that at least partially translucent surface material consists of at least one carrier substrate transparent to sunlight resembling a massive pane.

27. The device according to claim 1, characterized in that the partially translucent surface material is a window element, preferably for buildings, or part of a window element.

28. The device according to claim 1, characterized in that the partially translucent surface material takes the form of a single carrier substrate transparent to sunlight, with the optically active surface structures and the optically switchable layer or the microstructure surfaces optically active in the near field range with the optically active layer on a respective shared surface upper side or on respective different surface upper sides.

29. The device according to claim 1, characterized in that two carrier substrates transparent to sunlight are provided, whose surface upper sides are spaced apart opposite each other, that the optically active surface structures on one of the two opposing surface upper sides and the optically switchable layer or the microstructure surfaces optically active in the near field on the opposing surface upper side are provided with the optically active layer.

30. The device according to claim 29, characterized in that the two carrier substrates transparent to sunlight are designed as windowpanes of a dual glazing, whose opposing surface upper sides incorporate that intermediate space of the panes.

31. The device according to claim 1, characterized in that the at least partially translucent surface material is designed as a kind of film.

32. The device according to claim 21, characterized in that the film is attached to a carrier substrate transparent to sunlight.

33. The device according to claim 1, characterized in that the optically active surface structures are geometrically uniform and, based on the presumption of a prescribed periodic sequence, are formed and arranged on the surface upper side, and that the optically switchable layer is applied to all surface structures over their entire surface, or only selectively to specific partial areas of the surface structures.

34. The device according to claim 33, characterized in that an optically non-switchable layer with absorption, transmission and/or reflection properties not dependent on time is selectively applied in other areas of the surface structures in combination with an optically switchable layer selectively applied in specific partial areas of the surface structures.

35. The device according to claim 1, characterized in that the surface structures exhibit corners or edges that are locally coated with an optically switchable or optically active layer with absorption, transmission and/or reflection properties not dependent on time.
